(19) United States
(12) Patent Application Publication
(10) Pub. No.: US 2012/0080055 A1
(43) Pub. Date: Apr. 5, 2012

(54) Pulsed Detonation Cleaning Systems and Methods

(75) Inventors: Tian Xuan Zhang, Raytown, MO (US); David Michael Chapin, Raytown, MO (US)

(73) Assignee: GENERAL ELECTRIC COMPANY, Schnectady, NY (US)

(21) Appl. No.: 12/895,920

(22) Filed: Oct. 1, 2010

(51) Int. Cl. B08B 7/00

(52) U.S. Cl. 134/19; 134/105

(57) ABSTRACT

The present application provides a pulsed detonation cleaning system for cleaning an enclosed structure. The pulsed detonation cleaning system may include a pulsed detonation combustor cleaner and an external fuel-air flow. The pulsed detonation combustor cleaner delivers the external fuel-air flow into the enclosed structure and ignites the external fuel-air flow to clean the enclosed structure.

### TECHNICAL FIELD

The present application relates generally to pulsed detonation cleaning systems and methods and more particularly relates to pulsed detonation cleaning systems and methods using the combustion of an external fuel-air mixture for cleaning tubes and other types of enclosed surfaces.

### BACKGROUND OF THE INVENTION

Industrial boilers operate by using a heat source to create steam from water or another type of a working fluid. The steam may be used to drive a turbine or other type of load. The heat source may be a combustor that burns a fuel-air mixture therein. Heat may be transferred to the working fluid from the combustor via a heat exchanger. Burning the fuel-air mixture, however, may generate residues on the surface of the combustor, heat exchangers, and the like. Further, the working fluid flowing through the tubes of the heat exchangers and other types of enclosures also may develop residues and other deposits therein. The presence of these residues and other deposits may inhibit the efficient transfer of heat to the working fluid. This reduction in efficiency may be reflected by an increase in the exhaust gas temperature from the backend of the process as well as an increase in the fuel burn rate required to maintain steam production and energy output. Periodic removal of the residues and deposits thus may help maintain the overall system efficiency. Typically, the complete removal of the deposits generally requires the boiler or other system to be shut down while the cleaning process is performed.

Pressurized steam, water jets, acoustic waves, mechanical hammering, and other methods having been used to remove these internal deposits while offline. For example, mechanical methods may include different kinds of brushes, headers, and lances to mechanically pass through the tube. Chemical methods may include the use of different kinds of chemical solutions. Pneumatic/hydraulic methods may use compressed air or high pressure water jets. Vacuum methods also may be used. Finally, combinations of these methods also are known.

More recently, detonative combustion devices have been employed. Specifically, a pulsed detonation combustor external to the boiler, heat exchanger tubes, or other system may be used to generate a series of detonations or quasi-detonations that may be directed therein. The high speed shockwaves travel through the boiler, the tubes, or otherwise and loosen the deposits from the surfaces therein. The pulsed detonation combustor systems result in quick cleaning, however, tend to require a large footprint. Moreover, the strength/effectiveness of the shockwave decreases as it travels away from the detonation combustor such that there is a limit to the cleaning range.

There is thus a desire for cleaning systems and methods that are able to operate quickly to remove internal deposits in boilers, heat exchanger tubes, and the like so as to minimize downtime. It is further desirable that the systems and methods may operate within the existing environment, i.e., that the system is able to fit physically within the existing space restrictions while being able to reach all of the tubes or other surfaces that require cleaning with the most intense pressure wave throughout the vessel.

### SUMMARY OF THE INVENTION

The present application thus provides a pulsed detonation cleaning system for cleaning an enclosed structure. The pulsed detonation cleaning system may include a pulsed detonation combustor cleaner and an external fuel-air flow. The pulsed detonation combustor cleaner delivers the external fuel-air flow into the enclosed structure and ignites the external fuel-air flow to clean the enclosed structure.

The present application further provides a method of cleaning an enclosed structure with a pulsed detonation combustor cleaner. The method may include the steps of positioning the pulsed detonation combustor cleaner about an inlet of the enclosed structure, flowing an external fuel-air mixture into the enclosed structure from the pulsed detonation combustor cleaner, and igniting the external fuel-air mixture to clean the enclosed structure.

The present application further provides a pulsed detonation cleaning system for cleaning a tube. The pulsed detonation cleaning system may include a pulsed detonation combustor cleaner with a combustion chamber, a flow of air in communication with the combustion chamber, and a flow of gas in communication with the combustion chamber. The flow of air and the flow of gas mix in the combustion chamber to form an external fuel-air flow such that the pulsed detonation combustor cleaner delivers the external fuel-air flow into the tube and ignites the external fuel-air flow to clean the tube.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a known pulsed detonation combustor cleaner.

FIG. 2 is a schematic view of a pulsed detonation cleaning system as may be described herein.

FIG. 3 is a perspective view of the pulsed detonation cleaning system of FIG. 2 used in a multi-tube heat exchanger.

FIG. 4 is a perspective view of the pulsed detonation cleaning system of FIG. 2 used in a multi-tube heat exchanger with a header.

### DETAILED DESCRIPTION

As used herein, the term “pulsed detonation combustor” (“PDC”) refers to a device or a system that produces both a pressure rise and a velocity increase from the detonation or quasi-detonation of a fuel and an oxidizer. The PDC may be operated in a repeating mode to produce multiple detonations or quasi-detonations within the device. A “detonation” may be a supersonic combustion in which a shock wave is coupled to a combustion zone. The shock may be sustained by the energy release from the combustion zone so as to result in combustion products at a higher pressure than the combustion reactants. A “quasi-detonation” may be a supersonic turbulent combustion process that produces a pressure rise and a velocity increase higher than the pressure rise and the velocity increase produced by a sub-sonic deflagration wave. For simplicity, the terms “detonation” or “detonation wave” as used herein will include both detonations and quasi-detonations.

Exemplary PDC's, some of which will be discussed in further detail below, include an ignition device for igniting a combustion of a fuel/oxidizer mixture and a detonation chamber in which pressure wave fronts initiated by the combustion coalesce to produce a detonation wave. Each detonation or quasi-detonation may be initiated either by an external ignition source, such as a spark discharge, laser pulse, heat source, or plasma igniter, or by gas dynamic processes such as shock focusing, auto-ignition, or an existing detonation wave from another source (cross-fire ignition). The detonation chamber geometry may allow the pressure increase behind the detonation wave to drive the detonation wave and also to blow the combustion products themselves out an exhaust of the PDC.

Various chamber geometries may support detonation formation, including round chambers, tubes, resonating cavities, reflection regions, and annular chambers. Such chamber designs may be of constant or varying cross-section, both in area and shape. Exemplary chambers include cylindrical tubes and tubes having polygonal cross-sections, such as, for example, hexagonal tubes. As used herein, “downstream” refers to a direction of flow of at least one of the fuel or the oxidizer.

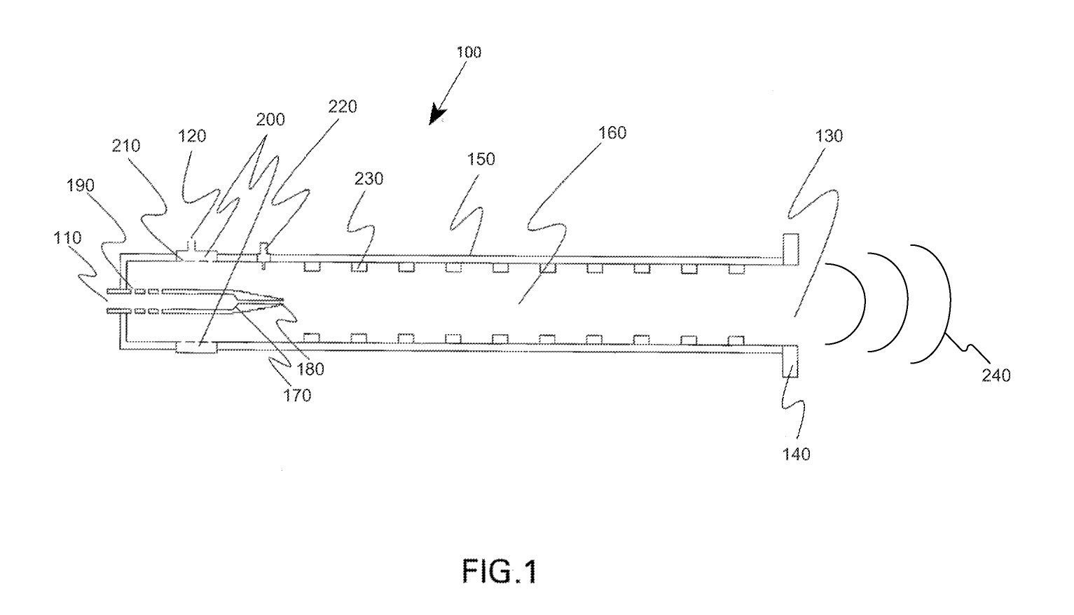

Referring now to the drawings, in which like numbers refer to like elements throughout the several views, FIG. 1 shows an example of a pulsed detonation combustor cleaner 100. The PDC cleaner 100 may extend along the illustrated x-axis from an upstream head end that includes an air inlet 110 and a fuel inlet 120 to an exit aperture 130 at a downstream end. The aperture 130 of the PDC cleaner 100 may be attached to a wall 140 of a boiler, a heat exchanger, or other structure to be cleaned. A tube 150 may extend from the head end to the aperture 130 so as to define a combustion chamber 160 therein. The air inlet 110 may be connected to a source of pressurized air. The pressurized air may be used to fill and purge the combustion chamber 160 and also may serve as an oxidizer for the combustion of the fuel.

The air inlet 110 may be connected to a center body 170 that may extend along the axis of the tube 150 and into the combustion chamber 160. The center body 170 may be in the form of a generally cylindrical tube that extends from the air inlet 102 and tapers to a downstream opening 180. The center body 170 also may include one or more air holes 190 along its length. The air holes 190 may allow the air flowing through the center body 170 to enter into the upstream end of the chamber 160. The opening 180 and the air holes 190 of the center body 170 may allow for directional velocity to be imparted to the air that is fed into the tube 150 through the air inlet 110. Such a directional flow may be used to enhance the turbulence in the injected air and also to improve the mixing of the air with the fuel present within the flow in the head end of the tube 150.

The air holes 190 may be disposed at multiple angular and axial locations about the axis of the center body 170. The angle of the air holes 190 may be purely radial to the axis of the center body 170. In other examples, the air holes 190 may be angled in the axial and circumferential directions so as to impart a downstream or rotational velocity to the flow from the center body 170. The flow through the center body 170 also may serve to provide cooling to the center body 170 so as to prevent an excessive heat buildup that could result in degradation therein.

The fuel inlet 120 may be connected to a supply of fuel that may be burned within the combustion chamber 160. A fuel plenum 200 may be connected to the fuel inlet 120. The fuel plenum 200 may be a cavity that extends around the circumference of the head end of the tube 150. A number of fuel holes 210 may connect the interior of the fuel plenum 200 with the interior of the tube 150. The fuel holes 210 may extend radially from the fuel plenum 200 and into the annular space between the wall of the tube 150 and the center body 170. As with the air holes 190, the fuel holes 210 may be disposed at a variety of axial and circumferential positions. In addition, the fuel holes 210 may be aligned to extend in a purely radial direction or may be canted axially or circumferentially with respect to the radial direction.

The fuel may be injected into the chamber 160 so as to mix with the air flow coming through the air holes 190 of the center body 170. The mixing of the fuel and the air may be enhanced by the relative arrangement of the air holes 190 and the fuel holes 210. For example, by placing the fuel holes 210 at a location such that fuel is injected into regions of high turbulence generated by the flow through the air holes 190, the fuel and the air may be more rapidly mixed so as to produce a more readily combustible fuel/air mixture. Fuel may be supplied to the fuel plenum 200 through the fuel inlet 120 via a valve that allows for the active control of the flow of fuel therethrough.

An ignition device 220 may be disposed near the head end of the tube 150. The ignition device 220 may be located along the wall of the tube 150 at a similar axial position to the end of the center body 170. This position allows for the fuel and the air coming through holes 190, 210 respectively to mix prior to flowing past the ignition device 220. The ignition device 220 may be connected to a controller so as to operate the ignition device 220 at desired times as well as providing feedback signals to monitor operations.

The tube 150 also may contain a number of obstacles 230 disposed at various locations along the length thereof. The obstacles 230 may take the form of ribs, indents, pins, or any structure. The obstacles 230 may be uniform or random in size, shape, or position. The obstacles 230 may be used to enhance the combustion as it progresses along the length of the tube 150 and to accelerate the combustion front into a detonation wave 240 before the combustion front reaches the aperture 130. The obstacles 230 shown herein may be thermally integrated with the wall of the tube 150. The obstacles 230 may include features that are machined into the wall, formed integrally with the wall (by casting or forging, for example), or attached to the wall, for example by welding. Other types of manufacturing techniques may be used herein.

Air thus enters through the air inlet 110 and passes through the downstream opening 180 and the air holes 190 of the center body 170. Likewise, fuel flows through the fuel inlets 120 and through the gas holes 210 of the fuel plenum 200. The fuel and the air are then ignited by the ignition device 220 into a combustion flow and the resultant detonation waves 240. The detonation waves 240 may extend along the length of the inner tube 270. Turbulence may be provided by the obstacles 230 therein. The detonation waves 240 then may exit via the exit aperture 130 such that the detonation waves 240 may be used for cleaning purposes in a boiler, a heat exchanger, and the like. Other configurations may be used herein.

The tube 150, the obstacles 230, the center body 170, and the other elements herein may be fabricated using a variety of materials suitable for withstanding the temperatures and pressures associated with repeated detonations. Such materials may include, but are not limited to, Inconel, stainless steel, aluminum, carbon steel, and the like. Other materials may be used herein.

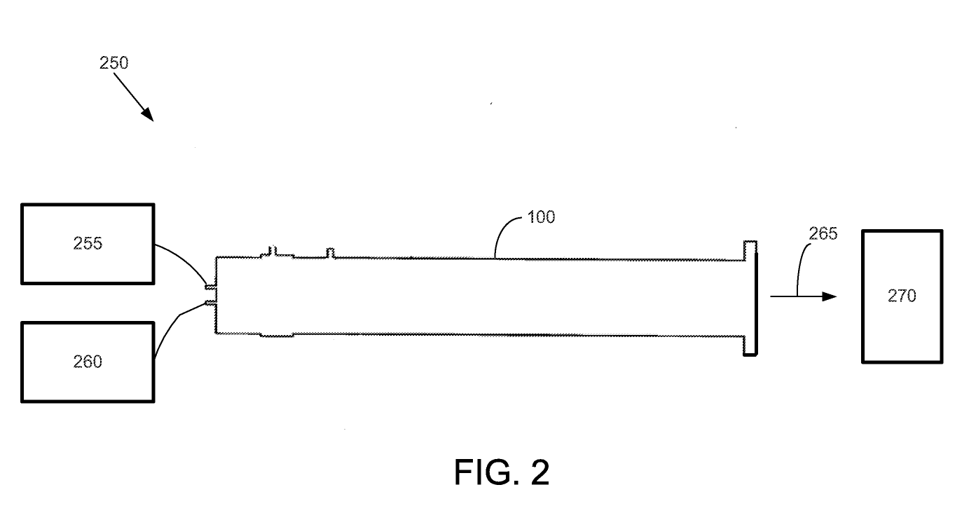

FIG. 2 shows an example of a pulsed detonation cleaning system 250 as may be described herein. The pulsed detonation cleaning system 250 may include the PDC cleaner 100 or a similar type of pulsed detonation device. The pulsed detonation cleaning system 250 may be in communication with a flow of air 255 and a flow of fuel 260 in a manner similar to that described above. The PDC cleaner 100 of the pulsed detonation cleaning system 250 also may produce an external fuel-air flow 265 as will be described in more detail below to clean any type of enclosed surface 270.

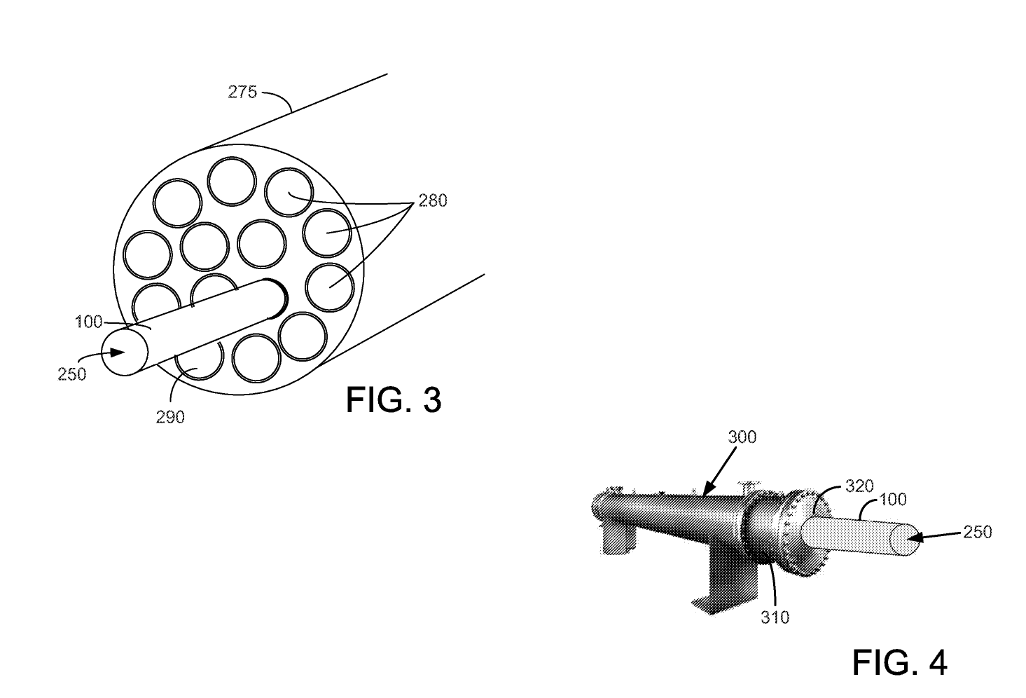

For example, FIG. 3 shows the pulsed detonation cleaning system 250 used with an example of a heat exchanger 275 as the enclosed surface 270. Specifically, the pulse detonation cleaning system 250 may be used with a tube 280 within the overall heat exchanger 270. Other configurations may be used herein.

In use, the PDC cleaner 100 may be positioned about an inlet 290 of the tube 280 of the heat exchanger 270 or other type of structure. The flow of air 255 may enter through the air inlet 110 and pass through the downstream opening 180 and the air holes 190 of the center body 170 of the PDC cleaner 100. Likewise, the flow of fuel 260 may flow through the fuel inlets 120 and the gas holes 210 of the fuel plenum 200. Instead of being immediately ignited by the ignition device 220, the flow of air 255 and the flow of fuel 260 may mix within the combustion chamber 160 and form the external fuel-air flow 265. The external fuel-air flow 265 may pass out of the PDC cleaner 100 and into the inlet 290 of the tube 280. The external fuel-air flow 265 thus may fill the tube 280. The ignition device 220 then may ignite the external fuel-air flow 265 so as to create the detonation waves 240 within the combustion chamber 160 and through out the length of the tube 280. The detonation waves 240 may propagate at supersonic speeds therethrough and generate high local pressure within the tube 280. This high local pressure may serve to clean the residue and other deposits inside of the tube 280. This process then may be repeated for any or all of the other tube 280 within the heat exchanger 275.

FIG. 4 shows a further embodiment of a heat exchanger 300. In this embodiment, the heat exchanger 300 also includes a number of the tube 280 therein. The heat exchanger 300 further includes a header 310. The header 310 may be in communication with each of the tubes 280. The header 310 may have a single inlet 320. Other configurations may be used herein.

As described above, the pulsed detonation cleaning system 250 may employ the PDC cleaner 100 and the external fuel-air flow 265 to clean the tubes 280 therein. Specifically, the PDC cleaner 100 may be positioned about the inlet 320 of the header 310. The PDC cleaner 100 may provide the fuel-air flow 265 to the inlet 320 of the header 310 such that the fuel-air flow 265 fills the header 310 and each of the tubes 280 of the heat exchanger 300. The ignition devices 220 then may ignite the external fuel-air flow 265 so as to create the detonation waves 240. As above, the detonation waves 240 may propagate through all of the tubes 280 at supersonic speeds and generate high local pressure. The high local pressure cleans each of the tubes 280 so as to remove the residue or other deposits therein.

Although the pulsed detonation cleaning system 250 has been described in terms of cleaning the tubes 280 of the heat exchangers 270, 300, the pulsed detonation cleaning system 250 may be used with any type of heat exchanger, boiler, pipeline, or other type of enclosed structure 270. The pulsed detonation cleaning system 250 thus generates a controlled supersonic wave to provide cleaning therein. Multiple pulsed detonation cleaning systems 250 may be used herein together. Likewise, the pulsed detonation cleaning system 250 may be used with other types of cleaning systems and the like.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A pulsed detonation cleaning system for cleaning an enclosed structure, comprising:
a pulsed detonation combustor cleaner; and
an external fuel-air flow;
wherein the pulsed detonation combustor cleaner delivers the external fuel-air flow into the enclosed structure and ignites the external fuel-air flow to clean the enclosed structure.

2. The pulsed detonation cleaning system of claim 1, further comprising a flow of air and a flow of fuel in communication with the pulsed detonation combustor cleaner.

3. The pulsed detonation cleaning system of claim 2, wherein the pulsed detonation combustor cleaner comprises a combustion chamber to mix the flow of air and the flow of fuel therein.

4. The pulsed detonation cleaning system of claim 1, wherein the pulsed detonation combustor cleaner comprises an ignition device to ignite the external fuel-air flow.

5. The pulsed detonation cleaning system of claim 1, further comprising a plurality of detonation waves resulting from the ignition of the external fuel-air flow.

6. The pulsed detonation cleaning system of claim 1, wherein the enclosed structure comprises a tube.

7. The pulsed detonation cleaning system of claim 1, wherein the enclosed structure comprises a heat exchanger.

8. The pulsed detonation cleaning system of claim 1, wherein the enclosed structure comprises a heat exchanger with a header in communication with a plurality of tubes.

9. A method of cleaning an enclosed structure with a pulsed detonation combustor cleaner, comprising:
positioning the pulsed detonation combustor cleaner about an inlet of the enclosed structure;
flowing an external fuel-air mixture into the enclosed structure from the pulsed detonation combustor cleaner; and
igniting the external fuel-air mixture to clean the enclosed structure.

10. The method of claim 9, further comprising the step of mixing a flow of fuel and a flow of air in a combustion chamber to create the external fuel-air flow.

11. The method of claim 9, wherein the step of flowing an external fuel-air flow into the enclosed structure from the pulsed detonation combustor cleaner comprises flowing the external fuel-air flow into a tube.

12. The method of claim 9, wherein the step of flowing an external fuel-air flow into the enclosed structure from the pulsed detonation combustor cleaner comprises flowing the external fuel-air flow into a heat exchanger.

13. The method of claim 9, wherein the step of flowing an external fuel-air flow into the enclosed structure from the pulsed detonation combustor cleaner comprises flowing the external fuel-air flow into a heat exchanger with a header in communication with a plurality of tubes.

14. The method of claim 9, further comprising the step of creating a plurality of detonation waves within the enclosed structure.

15. The method of claim 14, further comprising the step of creating high pressure from the plurality of detonation waves.

16. A pulsed detonation cleaning system for cleaning a tube, comprising:
a pulsed detonation combustor cleaner;
the pulsed detonation combustor cleaner comprising a combustion chamber;
a flow of air in communication with the combustion chamber; and
a flow of gas in communication with the combustion chamber;
wherein the flow of air and the flow of gas mix in the combustion chamber to form an external fuel-air flow such that the pulsed detonation combustor cleaner delivers the external fuel-air flow into the tube and ignites the external fuel-air flow to clean the tube.

17. The pulsed detonation cleaning system of claim 16, wherein the pulsed detonation combustor cleaner comprises an ignition device to ignite the external fuel-air flow.

18. The pulsed detonation cleaning system of claim 16, further comprising a plurality of detonation waves resulting from the ignition of the external fuel-air flow within the tube.

19. The pulsed detonation cleaning system of claim 16, wherein the tube comprises a heat exchanger.

20. The pulsed detonation cleaning system of claim 16, wherein the tube comprises a heat exchanger with a header in communication with a plurality of tubes.
